(19) United States
(12) Patent Application Publication
(10) Pub. No.: US 2013/0024928 A1
(43) Pub. Date: Jan. 24, 2013

(54) SECURE NETWORK COMMUNICATIONS FOR METERS

(71) Applicants: Robert James Burke, Dallas, TX (US); Prateek Sangal, Frisco, TX (US); Robert Daniel Maher, III, Plano, TX (US)

(72) Inventors: Robert James Burke, Dallas, TX (US); Prateek Sangal, Frisco, TX (US); Robert Daniel Maher, III, Plano, TX (US)

(21) Appl. No.: 13/188,995

(22) Filed: Jul. 22, 2011

(51) Int. Cl. G06F 15/16; G06F 21/20

(52) U.S. Cl. 726/12; 709/219; 726/11

(57) ABSTRACT

A system and method are provided for secure network communications. A proxy server receives meter data, from a meter of a set of meters via a local network, for an energy management server. The proxy server uses secure communications to send the meter data via a non-secure network to the energy management server.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The embodiments of the present disclosure relate generally to network communications, and more specifically to a system and method for secure network communications for meters.

### BACKGROUND

Enterprises promote efforts to increase operational efficiencies by measuring and improving energy utilization. An enterprise may add additional meters to the enterprise's electrical infrastructure, such as facilities and production lines, to monitor sub-systems' usage, areas' usage, and the enterprise's usage. Some electrical, gas, and water meters use internet protocol to receive meter configuration information and transmit meter data. When these meters are installed and controlled from within the enterprise, often these meters are connected to a local network, or a local area network (LAN), of the enterprise. Once these meters are connected to a local area network, an information technology organization may enforce and administer network and security policies for these meters. Often strict limitations on both outbound communications from these meters and inbound communications to these meters may limit the ability to host meter data and effect control outside the enterprise's network domain. Meters are typically configured with an internet protocol address of an outbound server. If the outbound server resides outside the enterprises' private network, the enterprise's firewall would need to support a large number of continuously open connections, one for each meter. However, maintaining a large number of continuously open connections is highly insecure and violates many corporate security policies.

### SUMMARY

A system and method are provided for secure network communications for meters. A proxy server is located within an enterprise's network, and concentrates all of the outbound meter communication through the proxy server, inspects the meter data, applies policies based on the meter data content, encrypts the data, and forwards the information to an energy management server. The proxy server uses secure communications to send the meter data over a non-secure network to the energy management server. Rather than the energy management server supporting a large number of continuously open connections, one for each meter, the energy management server receives meter data from a single source, the proxy server, which communicates via secure communications over the non-secure network. The proxy server may also use the secure communications to receive meter configuration information for the meters from the energy management server over the non-secure network, and send the received meter configuration information to the meters via the local network.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure; and

FIG. 2 presents a sample method of the present disclosure.

### DETAILED DESCRIPTION OF SOME EMBODIMENTS

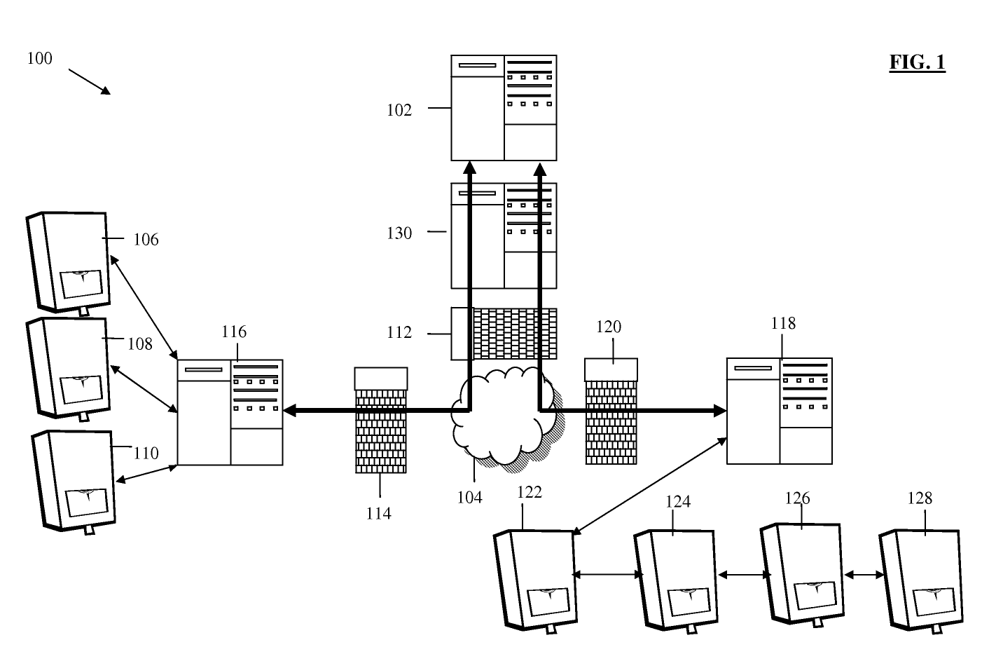

FIG. 1 presents a sample system 100 of the present disclosure. The system 100 includes a server 102, a non-secure network 104, a first set of meters 106-110, a hosted service firewall 112, and a first enterprise firewall 114. The server 102 may be an energy management server 102 that monitors an enterprise's energy usage by receiving meter data from the first set of meters 106-110 through the first enterprise firewall 114 via the non-secure network 104, which may be the Internet 104, and the hosted service firewall 112. However, the need to frequently receive meter data from the first set of meters 106-110 would require that first enterprise firewall 114 would need to support a large number of continuously open connections, one for each of the first set of meters 106-110. Maintaining a large number of continuously open connections is highly insecure, and violates many corporate security policies.

Therefore, the system 100 also includes a first proxy server 116. A server is a computer that manages access to a resource in a network, and a proxy server is a computer which acts as an intermediary for requests from clients seeking a resource from another server. However, the first proxy server 116 does not act as an intermediary for requests from the meter 106 seeking a resource from the energy management server 102, as the meter 106 seldom, if ever, requests a resource, such as meter configuration information, from the energy management server 102. Instead, the system 100 uses a proxy server, such as the first proxy server 116, to act as an intermediary in the opposite direction by receiving a resource, such as meter data from the meter 106 via a local area network, and sending the resource to a server, such as the energy management server 102. The first proxy server 116, which may be referred to as the secure meter proxy server 116, communicates in a local area network with the first set of meters 106-110.

The system 100 may also include a second proxy server 118, which may be referred to as the secure meter proxy server 118, a second enterprise firewall 120, and a second set of meters 122-128. The second proxy server 118 communicates in a local area network with the second set of meters 122-128. The meter 122 communicates with the meters 124-128 via an electronic industries alliance (EAI)-485 or RS-485 standard. The system 100 may also include an energy management proxy server 130, which may serve as an intermediary for meter data sent by the proxy servers 116 and 118 to the energy management server 102. The energy management proxy server 130 may handle communications with the proxy servers 116 and 118, thereby enabling the energy management server 102 to focus more on data aggregation and processing. Although FIG. 1 depicts one of each of the elements 102-130, the system 100 may include any number of each of the elements 102-130. Any additional proxy servers may communicate with the energy management proxy server 130 in parallel or in series with the proxy servers 116 and 118.

The proxy servers 116 and 1184 communicate through the first enterprise firewall 114 and the second enterprise firewall 120 via the non-secure network 104, through the hosted service firewall 112, with the energy management proxy server 130. Rather than the first enterprise firewall 114 and the second enterprise firewall 120 supporting a large number of continuously open connections, one for each of the meters 106-110 and 122-128, the first enterprise firewall 114 and the second enterprise firewall 120 receive meter data from fewer sources, the two proxy servers 116 and 118, which communicate via secure communications over the non-secure network 104. The proxy servers 116 and 118 use secure communications to traverse the non-secure network 104 to communicate with the energy management proxy serve 130, which is secure behind the hosted service firewall 112.

The proxy servers 116 and 118 may provide further benefits beyond the elimination of a requirement for the first enterprise firewall 114 and the second enterprise firewall 120 to support a large number of continuously open connections. The proxy servers 116 and 118 may conduct a deep packet inspection of the meter data received from the meters 106-110 and 122-128 by examining the content, the source address, and the destination address of each meter data packet. The inspection can match transmitted meter data to the established policies for meter data. The inspection can also verify that the meter data is received from the correct meter sources. The inspection can additionally protect the energy management proxy server 130 by filtering the content to ensure that viruses and/or denial of service messages are not sent to the energy management proxy server 130. The filtering of content ensures that only meter data is sent to the energy management proxy server 130, and confidential or private data is not transmitted, stored, or logged.

Furthermore, the proxy servers 116 and 118 may generate a meter health report based on the meter data received from a meter. For example, a meter that provides meter data on less than half of the occasions when the meter was expected to provide meter data may be considered as a failed meter, whereas a meter that provides meter data on 95% of the expected occasions and then 90% of the expected occasions may be considered as a failing meter. The proxy servers 116 and 118 may identify and report the problems associated with failed meters and failing meters by executing a diagnostic function on a meter identified as failed or failing in a meter health report.

The proxy servers 116 and 118 may also use the secure communications to receive meter configuration information for the meters 106-110 and 122-128 from the energy management proxy server 130 over the non-secure network 104, and send the received meter configuration information to the intended meters 106-110 and 122-128 via the corresponding local area networks. When the system 100 is initialized for operation, the proxy servers 116 and 118 may use any received meter configuration information to determine from which of the meters 106-110 and 122-128 to expect meter data.

The proxy servers 116 and 118 may also execute network address translations. For example, the meter 106 sends meter data to the first proxy server 116 in a meter data packet that includes the source address for the meter 106 and the destination address for the first proxy server 116. The first proxy server 116 executes a network address translation for this meter data packet by modifying the source address to reflect the new source address of the first proxy server 116 and by modifying the destination address to reflect the new destination address of the energy management proxy server 130. When this network translation is completed, the first proxy server 116 is ready to send the meter data packet to the energy management proxy server 130. Likewise, the proxy servers 116 and 118 may execute network address translations for packets of meter configuration information received from the energy management proxy server 130.

The proxy servers 116 and 118 may also promote efficient operation and maintenance of the enterprise firewalls 114 and 120. Rather than the enterprise firewalls 114 and 120 being configured to permit meter data to be sent from the source addresses of the many meters 106-110 and 122-128 the enterprise firewalls 114 and 120 are configured to permit meter data to be sent from only the two source addresses of the proxy servers 116 and 118. The enterprise firewalls 114 and 120 may then safely exclude the transmission of any meter data that is not from the source address of either the first proxy server 116 or the second proxy server 118. Likewise, the hosted service firewall 112 is configured to permit meter data to be sent from only the two source addresses of the enterprise firewalls 114 and 120. Similarly, the hosted service firewall 112 may then safely exclude the transmission of any meter data that is not from the source address of either the first enterprise firewall 114 or the second enterprise firewall 120.

Similar to meter data transmission, the hosted service firewall 112 is configured to permit meter configuration information to be sent to the meters 106-110 and 122-128 through only two destination addresses, the destination addresses for the proxy servers 116 and 118. Similarly, the hosted service firewall 112 may then safely exclude the transmission of any meter configuration information that does not include the destination address for either the first proxy server 116 or the second proxy server 118. Also, the enterprise firewalls 114 and 120 are configured to permit meter configuration information to be sent for the meters 106-110 and 122-128 using only the two destination addresses for the proxy servers 116 and 118. Similarly, the enterprise firewalls 114 and 120 may then safely exclude the transmission of any meter configuration information that does not include the destination address for either the first proxy server 116 or the second proxy server 118.

The proxy servers 116 and 118 may further promote efficient operation and maintenance of the enterprise firewalls 114 and 120. For example, if any of the meters 106-110 and 122-128 are moved, changed, or deleted, the enterprise firewalls 114 and 120 do not have to be reconfigured because they would continue to exclude meter configuration information to all addresses except for the same destination addresses for the proxy servers 116 and 118 and exclude meter data from all addresses except for the same source addresses for the proxy servers 116 and 118. Likewise, if any meters are added to the meters 106-110 and 122-128, the added meters would send their meter data to only the destination addresses of the proxy servers 116 and 118 and receive meter configuration information from only the source addresses for the proxy servers 116 and 118. Therefore, the enterprise firewalls 114 and 120 do not have to be reconfigured for an added meter because they already permit meter configuration information to be sent to only the destination addresses for the proxy servers 116 and 118 and meter data to be received from only the source addresses of the proxy servers 116 and 118.

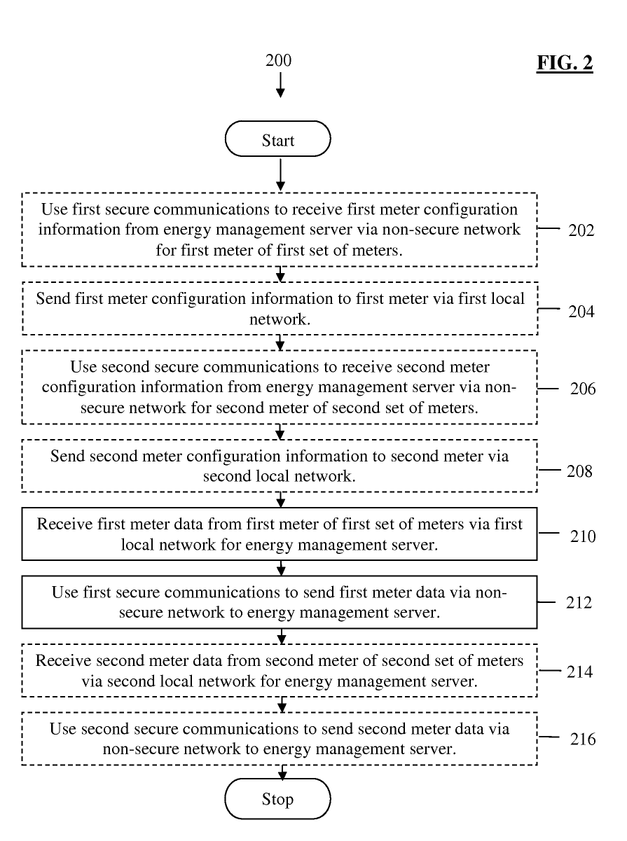

FIG. 2 presents a sample method 200 of the present disclosure. The system 100 may execute the method 200 to enable secure network communications between the meters 106-110 and 122-128 and the energy management proxy server 130.

In box 202, first secure communications are optionally used to receive first meter configuration information from an energy management server via a non-secure network for a first meter of a first set of meters. For example, the first proxy server 116 uses an internet protocol security tunnel to receive meter configuration information from the energy management proxy server 130 via the Internet 104 for the meter 106.

In box 204, first meter configuration information is optionally sent to a first meter via a first local network. For example, the first proxy server 116 sends the meter configuration information it received to the meter 106 via its local area network.

In box 206, second secure communications are optionally used to receive second meter configuration information from an energy management server via a non-secure network for a second meter of a second set of meters. For example, the second proxy server 118 uses an internet protocol security tunnel to receive meter configuration information from the energy management proxy server 130 via the Internet 104 for the meter 122.

In box 208, second meter configuration information is optionally sent to a second meter via a second local area network. For example, the second proxy server 118 sends the meter configuration information it received to the meter 122 via its local area network.

In box 210, first meter data from a first meter of a first set of meters is received via a first local area network for an energy management server. For example, the first proxy server 116 receives meter data from the meter 106 via its local area network for the energy management proxy server 130.

In box 212, first secure communications are used to send first meter data via a non-secure network to an energy management server. For example, the first proxy server 116 uses an internet protocol security tunnel to send the meter data it received via the Internet 104 to the energy management proxy server 130.

In box 214, second meter data from a second meter of a second set of meters is optionally received via a second local area network for an energy management server. For example, the second proxy server 118 receives meter data from the meter 122 via its local area network for the energy management proxy server 130.

In box 216, second secure communications are optionally used to send the second meter data via the non-secure network to the energy management server. For example, the second proxy server 118 uses an internet protocol security tunnel to send the meter data it received via the Internet 104 to the energy management proxy server 130. The method 200 may be repeated as desired.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A system for secure network communications for meters, the system including:
a proxy server that receives meter data, from a meter of a set of meters via a local network, for an energy management server; and uses secure communications to send the meter data via a non-secure network to the energy management server.

2. A system as in claim 1, wherein the proxy server further uses the secure communications to receive meter configuration information, from the energy management server via the non-secure network, for a meter; and sends the meter configuration information to the meter via the local network.

3. A system as in claim 2, wherein the proxy server further configures to expect the meter data from the meter based on receipt of the meter configuration information.

4. A system as in claim 2, wherein the proxy server further modifies at least one of a destination address and a source address in response to at least one of receipt of the meter data and receipt of the meter configuration information.

5. A system as in claim 1, wherein the secure communications includes an Internet protocol security tunnel.

6. A system as in claim 1, wherein the non-secure network includes the Internet.

7. A system as in claim 1, wherein the set of meters are connected in a series.

8. A system as in claim 7, wherein the set of meters are connected in the series via an electronic industries alliance 485 standard.

9. A system as in claim 1, wherein the secure communications communicate through a firewall.

10. A system as in claim 9, wherein the firewall includes a rule that permits meter data to be sent to the energy management server from only the proxy server.

11. A system as in claim 1, further including an energy management proxy server that receives the meter data from the proxy server via the secure communications and sends the meter data to the energy management server.

12. A system as in claim 2, further including an energy management proxy server that receives the meter configuration information from the energy management server and sends the meter configuration information to the proxy server via the secure communications.

13. A system as in claim 1, further including an additional proxy server that communicates with the energy management server in series with the proxy server.

14. A system as in claim 2, further including an additional proxy server that communicates with the energy management server in parallel with the proxy server.

15. A computer-implemented method for secure network communications for meters, the computer-implemented method including the steps of:
receiving, by a proxy server, meter data, from a meter of a set of meters via a local network, for an energy management server; and
using, by the proxy server, secure communications to send the meter data via a non-secure network to the energy management server.

16. A computer-implemented method as in claim 15, wherein receiving the meter data includes filtering, by the proxy server, to send meter data content that includes only meter data.

17. A computer-implemented method as in claim 15, further including generating, by the proxy server, a meter health report based on the meter data received from the meter.

18. A computer-implemented method as in claim 17, further including executing, by the proxy server, a diagnostic function on the meter based on the meter health report.

19. A system for secure network communications for meters, the system including:
a first proxy server that uses first secure communications to receive first meter configuration information, from an energy management server via a non-secure network, for a first meter of a first set of meters; and sends the first meter configuration information to the first meter via a first local network; and
a second proxy server that uses second secure communications to receive second meter configuration information, from the energy management server via the non-secure network, for a second meter of a second set of meters; and sends the second meter configuration information to the second meter via a second local network.

20. A system as in claim 19, wherein the first proxy server further receives first meter data, from a first meter of a first set of meters via the first local network, for the energy management server; and further uses the first secure communications to send the first meter data via the non-secure network to the energy management server; and
wherein the second proxy server further receives second meter data, from a second meter of a second set of meters via the second local network, for the energy management server; and uses the second secure communications to send the second meter data via the non-secure network to the energy management server.
